(19) United States
(12) Patent Application Publication
(10) Pub. No.: US 2026/0270693 A1
(43) Pub. Date: Sep. 10, 2026

(54) ACCESS POINT MIGRATION WITHIN NETWORK

(71) Applicant: ADEMCO INC., Golden Valley, MN (US)

(72) Inventors: Sheetal R. Kadam, Bangalore (IN); Anand Kavatekar Narayan Rao, Bangalore (IN); Sachin Joy, Bangalore (IN)

(73) Assignee: RESIDEO LLC, Golden Valley, MN (US)

(21) Appl. No.: 19/163,882

(22) PCT Filed: Oct. 2, 2023
(86) PCT No.: PCT/US2023/075720

§ 371 Date: Sep. 10, 2025

(30) Foreign Application Priority Data
Mar. 14, 2023 (IN) 202341017086

(51) Int. Cl. H04W 12/0431; H04W 12/73; H04W 36/30

(52) U.S. Cl. CPC H04W 12/0431; H04W 12/73; H04W 36/302

(57) ABSTRACT

A method includes transmitting network access point data from a hub device of a network to a sensor device of that network, where the sensor device is in communication with a first access point of a first sub-network of that network; using at least an address of the second access point of the second sub-network to transmit a transfer request from the sensor device to the second access point of the second sub-network; in response to receiving the transfer request from the sensor device, transmitting, from the second access point of the second sub-network, a second sub-network key to the sensor device; and using, at the sensor device, the second sub-network key to communicate with the second access point.

### RELATED CASE

This disclosure claims priority to Indian provisional patent application No. 202341017086, filed on Mar. 14, 2023, the contents of which are hereby incorporated by reference.

### TECHNICAL FIELD

This disclosure relates to networks, particularly networks used in, for example, premises (e.g., home) monitoring systems, comfort systems, and security systems. For example, embodiments are disclosed herein relating to a device migrating from communicative association with one access point of a network to communicative association with another, different access point of that network.

### BACKGROUND

A premises network may use a wireless network protocol to connect devices within the premises. For example, a hub device may use IEEE 802.15.4 to connect to over one hundred sensor devices in a premises to the hub device via one or more access points. The hub device may then collect sensor data collected by the sensor devices at the premises. For instance, the hub device may collect temperature readings from multiple temperature sensors arranged at the premises and output the temperature readings to a thermostat that controls an HVAC system using the temperature readings. In another instance, the hub device may collect door/window sensor readings and output the door/window sensor readings to a premises security sensor.

For premises that cover a relatively large area, more than one access point can be included in the premises network. For example, a hub device can communication with one or more sensor devices of a first personal area network (PAN) via a first access point for that first PAN (e.g., a first sub-network of the premises network) and the hub device can communicate with one or more sensor devices of a second PAN via a second access point for that second PAN (e.g., a second sub-network of the premises network). In this way, the hub device, sensor devices, and first and second access points can define a premises network that includes multiple, different PANs, and the hub device can transmit data to, and receive data from, the sensor devices via the first and second access points. The use of multiple access points at the premises network can help to expand the distance the premises network can cover.

### SUMMARY

In general, this disclosure relates to systems, devices, and techniques for device migration from data communication with one access point to data communication with another, different access point. For example, embodiments are disclosed herein relating a device (e.g., wireless sensor device) at a premises migrating from communicative association with a first access point of a premises network at the premises to communicative association with a second, different access point of that same premises network at the premises. This can include the first access point defining a first personal area network (PAN) of the premises network at the premises and the second, different access point defining a second, different PAN of the premises network at the premises, and, as such, a device (e.g., wireless sensor device) at a premises can be configured to migrate from data communication within the first PAN to data communication with the second, different PAN within the same premises network at the same premises.

In many applications of such wireless communication, a single premises network can include multiple zones or partitions, with each such partition defining a grouping of one or more devices (e.g., sensor devices) that communicate with a hub device (e.g., control panel) via an access point of that partition. In order to facilitate wireless communication between the hub and the devices of the various partitions via the various respective access points, the present disclosure describes an access point migration module for executing device communication migration from one access point, for instance at one partition, of the premises network to another access point, for instance at another partition, of the same premises network.

Embodiments disclosed herein can provide a number of useful advantages. For example, an overall premises network can experience communication loss with a device from time-to-time. Such communication loss with the device can occur for a variety of reasons, such as a communication distance between the device and an access point being relatively far and/or an interference source that generates noise interrupting wireless communication with the device. As such, the ability of the device to migrate from one wireless access point at a premises network to another, different wireless access point at the premises network can help to increase the reliability of the premises network by reducing instances of communication loss with the device within the premises network. This can be particularly useful in the context of certain home automation applications with security-related data is communicated and, thus, the reliability of data communication is relatively important. Moreover, this ability to help to increase the reliability of the premises network can be accomplished without migrating the device out of the premises network (e.g., without the device migrating from communication within the premises network to communication within another, different wide area network outside of the premises network).

Embodiments disclosed herein can utilize wireless communication to wireless connect devices using one or more (e.g., multiple) wireless protocols. One or more such wireless communication protocols can use time-division duplexing, such as, for example, time-division multiple access (TDMA). As used herein, time-division duplexing may refer to processes that allocates each communication of multiple communications at a particular frequency (e.g., a 2.4 GHz band) into a time “slot” of a repeating “superframe.” In contrast, frequency-division multiplexing may assign each communication of multiple communications to a unique frequency.

One embodiment includes a method. This method includes the step of transmitting network access point data from a hub device of a network to a sensor device of the network. The sensor device is in communication with a first access point of a first sub-network of the network. The network access point data includes an address of a second access point of a second sub-network of the network and in some embodiments additionally an operating channel of the second sub-network of the network. This method further includes the step of using at least the address of the second access point of the second sub-network and, when so included in the network access point data, the operating channel of the second sub-network to transmit a transfer request from the sensor device to the second access point of the second sub-network. This method further includes the step of, in response to receiving the transfer request from the sensor device, transmitting, from the second access point of the second sub-network, a second sub-network key to the sensor device. And, this method further includes the step of using, at the sensor device, the second sub-network key to communicate with the second access point.

In a further embodiment of this method, the method additionally includes receiving, at the sensor device from the hub device, a global network key prior to transmitting the network access point data from the hub device to the sensor device. For example, the transfer request transmitted from the sensor device to the second access point of the second sub-network can include the global network key. In such an example, the second sub-network key can be transmitted to the sensor device from the second access point in response to receiving, from the sensor device, the transfer request that includes the global network key. In some examples, the network access point data can further include network access point data for a third sub-network of the network, and the network access point data for the third sub-network can include an address of a third access point of the third sub-network and an operating channel of the third sub-network. In such examples, the method can further include, after transmitting the network access point data and prior to using the address of the second access point, scanning, at the sensor device, the operating channel of the second sub-network and the operating channel of the third sub-network. And, in such examples, the method can further include selecting, at the sensor device, the second sub-network to join based on the scan. For instance, the second sub-network can be selected to join based on the scan when the scan indicates a signal strength associated with the second sub-network is greater than a signal strength associated with the third sub-network.

In a further embodiment of this method, the method can further include, in response to the sensor device using the second sub-network key to communicate with the second access point, transmitting, from the second access point to the hub device, a status update indicating that the sensor device has migrated from communication with the first access point to communication with the second access point.

In a further embodiment of this method, the sensor device can migrate from communication with the first access point to communication with the second access point using the network access point data from the hub device and the second sub-network key from the second access point and without previously enrolling with the second access point data.

In a further embodiment of this method, the method can further include, prior to using at least the address of the second access point of the second sub-network and the operating channel of the second sub-network to transmit the transfer request from the sensor device to the second access point, losing communication between the sensor device and the first access point.

In a further embodiment of this method, the first access point and the second access point can each be included in the same premises network and coupled to the same hub device of that premises network. For instance, the first access point can be associated with a first PAN of the premises network and the second access point can be associated with a second, different PAN at the same premises network. As such, the sensor device can migrate from wireless communication with the first access point and out of communication with the first PAN to wireless communication with the second access point and into communication with the second PAN. Notably, this migration can occur without the sensor device having previously enrolled with the second PAN. As such, this migration capability can be useful in providing a dynamic ability to switch sensor device communication from one PAN via one access point in the premises network to another PAN via another access point in the premises network.

Another embodiment includes a sensor device. This sensor device embodiment includes programmable processing circuitry, a non-transitory storage medium coupled to the programmable processing circuitry, a sensor element configured to detect an ambient condition and the sensor coupled to the programmable processing circuitry, and a transceiver coupled to the programmable processing circuitry and configured to receive and transmit data via a network. The programmable processing circuitry can be configured to cause the sensor device to: transmit, via the transceiver, data to a first access point of a first sub-network of the network; receive, via the transceiver, network access point data from a hub device of a network, the network access point data including an address of a second access point of a second sub-network of the network and in some embodiments additionally an operating channel of the second sub-network of the network; use at least the address of the second access point of the second sub-network and, when so included in the network access point data, the operating channel of the second sub-network to transmit, via the transceiver, a transfer request from the sensor device to the second access point of the second sub-network; in response to transmitting the transfer request, receive, via the transceiver, a second sub-network key from the second access point of the second sub-network; and use the second sub-network key to communicate, via the transceiver, with the second access point.

In a further embodiment of this sensor device, the sensor device's programmable processing circuitry can be configured to cause the sensor device to store, at the non-transitory storage medium, the network access point data including the address of the second access point of the second sub-network of the network and the operating channel of the second sub-network of the network.

In a further embodiment of this sensor device, the sensor device's programmable processing circuitry can be configured to cause the sensor device to: receive, via the transceiver and from the hub device, a global network key prior to receiving the network access point data from the hub device. For example, the sensor device's programmable processing circuitry can be further configured to cause the sensor device to: transmit, via the transceiver, the transfer request to the second access point including the global network key.

Another embodiment includes a system. This system embodiment includes a hub device of a network; a first wireless access point coupled to the hub device and associated with a first sub-network of the network; a second wireless access point coupled to the hub device and associated with a second sub-network of the network; and a sensor device. The sensor device includes programmable processing circuitry that is configured to cause the sensor device to: transmit data to the first access point of the first sub-network; receive network access point data from the hub device of a network, the network access point data including an address of the second access point of the second sub-network and in some embodiments additionally an operating channel of the second sub-network; use at least the address of the second access point of the second sub-network and, when so included in the network access point data, the operating channel of the second sub-network to transmit a transfer request from the sensor device to the second access point of the second sub-network; in response to transmitting the transfer request, receive a second sub-network key from the second access point of the second sub-network; and use the second sub-network key to communicate with the second access point.

In a further embodiment of this system, the sensor device's programmable processing circuitry can further be configured to cause the sensor device to: receive, from the hub device, a global network key prior to receiving the network access point data from the hub device; and transmit the transfer request to the second access point including the global network key. For example, this system embodiment can further include a third wireless access point coupled to the hub device and associated with a third sub-network of the network. The network access point data received at the sensor device from the hub device can include network access point data for the third sub-network of the network that includes an address of the third access point of the third sub-network and an operating channel of the third sub-network. And, the sensor device's programmable processing circuitry can further be configured to cause the sensor device to: after transmitting the network access point data and prior to using the address of the second access point, scan the operating channel of the second sub-network and the operating channel of the third sub-network. For instance, in such an example, the sensor device's programmable processing circuitry can further be configured to cause the sensor device to: select the second sub-network to join based on the scan when the scan indicates a signal strength associated with the second sub-network is greater than a signal strength associated with the third sub-network.

The details of one or more examples of the disclosure are set forth in the accompanying drawings and the description below. Other features, objects, and advantages will be apparent from the description, drawings, and claims.

### BRIEF DESCRIPTION OF THE DRAWINGS

FIG. 1 is a conceptual block diagram illustrating an example of a premises network, in accordance with some examples of this disclosure.

FIG. 2 is a conceptual block diagram of a hub device and a sensor device, in accordance with some examples of this disclosure.

FIGS. 3A and 3B illustrate a conceptual block diagram of an embodiment of a system at a premises network with an example of a sensor device migrating from wireless communication with one wireless communication access point of the premises network to wireless communication with another wireless communication access point of the same premises network. Specifically, FIG. 3A illustrates the sensor device at a first sub-network of the premises network and in the process of migrating over to a second, different sub-network of the premises network 401, while FIG. 3B illustrates the premises network after the sensor device has migrated from the first sub-network to the second sub-network such that the sensor device at FIG. 3B is now part of the second sub-network.

FIG. 4 is a flow diagram illustrating of an example technique for sensor device migration from wireless communication with one access point of the premises network to wireless communication with another access point of the premises network, in accordance with some examples of this disclosure.

### DETAILED DESCRIPTION

Modern residential or commercial buildings or other types of premises (referred to generally as “premises”) can include a central “hub” device configured to manage one or more systems within the building, such as monitoring systems, comfort systems, or other security systems. The hub device may be in wireless communication with a number of other devices placed throughout the building. For example, the hub device can be part of a premises network, and the hub device can be in communication with multiple access points within that same premises network to wirelessly receive sensor data from any number of different sensor devices (e.g., motion sensors, air quality and/or temperature sensors, infrared sensors, door and/or window contact sensors, and/or other sensor devices) via a respective access point. Additionally, the hub device may wirelessly transmit commands or instructions to one or more controllable sensor devices via a respective access point. For example, the hub device may instruct a thermostat to adjust a temperature within the building by sensing a command to that thermostat via an access point that the thermostat is in wireless communication with.

Smart home, or home automation, devices may deploy many different wireless protocols for such communications to address the needs to the smart home. For instance, there can be standards-based protocols (Wi-Fi™, Zigbee™, Thread™, Zwave™, BLUETOOTH, DECT™, MATTER, etc.) and proprietary, manufacturer specific protocols.

A smart home system at a premises may include a collection of different sub-networks that operate at a common frequency band (e.g., 2.4 GHz band) suitable for premises networks. For example, a premises network of a smart home system can include a first sub-network associated with a first access point and a second, different sub-network associated with a second, different access point. The premises network and the sub-networks can use various types of wireless communication protocols to execute data communication between sensor devices and the hub device via one or more access points. Such wireless communication protocols can include one or more of a Wi-Fi™ communication protocol for a sub-network and/or the premises network, a BLUETOOTH communication protocol for a sub-network and/or the premises network, and an IEEE 802.15.4 communication protocol for a sub-network and/or the premises network each operating within a common frequency band (e.g. a 2.4 GHz frequency band). For instance, a hub device (e.g., a control panel) may allocate each sensor device to a time slot, also referred to herein as simply “slot,” of a superframe during a registration process. For example, the hub device may allocate a specified wireless communication protocol slot to one or more devices in the premises network (e.g., a Wi-Fi™ slot to one or more first devices, a BLUETOOTH slot to one or more second devices, and an IEEE 802.15.4 slot to one or more third devices). The hub device can output the superframe using a beacon signal of the superframe that specifies a beginning of the superframe. All devices of the premises network may synchronize to the beacon signal and output data at the 2.4 GHz frequency band according to the allocated slots of the superframe.

In one particular example, the hub device can use time divisional multiple access (TDMA) superframes for communication with up to a predetermined number of partitions in the premises network. For instance, the premises network can include three partitions each within the premises network and associated with a different access point. The hub device can use TDMA superframes to transmit data to, and receive data from, sensor devices at each of the three partitions within the premises network via the respective access point associated with each partition.

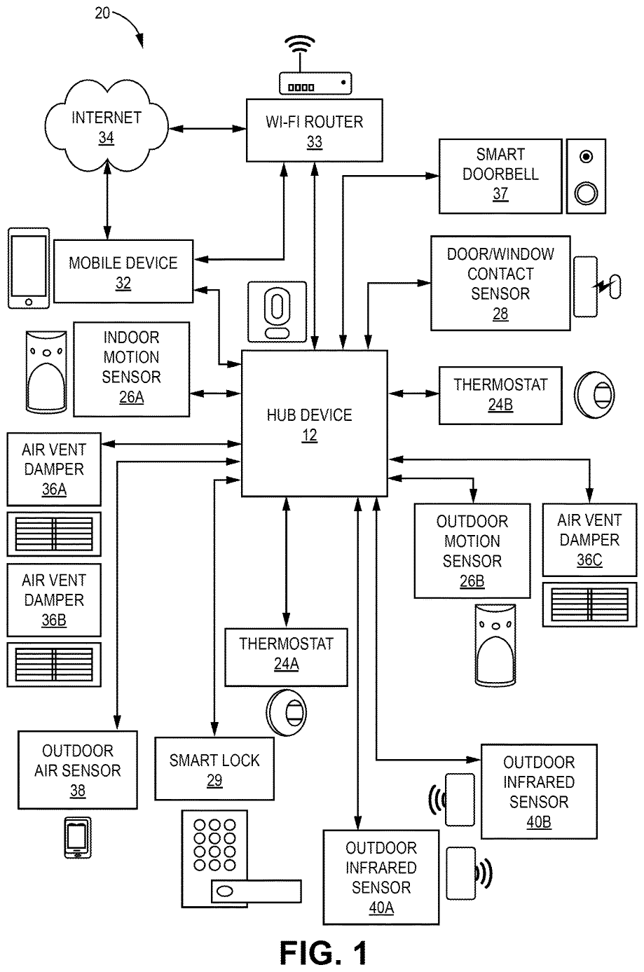

To further illustrate this concept, FIG. 1 shows a conceptual block diagram illustrating an embodiment of a premises network 20. For simplicity of illustration, the embodiment shown at FIG. 1 illustrates one access point 33 in communication with hub device 12, though as will be described elsewhere herein embodiments within the scope of the present disclosure can include multiple access points, each in communication with one or more sensor devices, in communication with the hub device 12.

Hub device 12 can include a computing device configured to operate one or more systems within a building, such as comfort, security, and/or safety systems. For example, as described further below, hub device 12 may include processing circuitry configured to receive data, such as received from one or more devices and/or from user input, and process the data in order to automate one or more systems within a building. For example, hub device 12 may automate, control, or otherwise manage systems including heating and cooling, ventilation, illumination, or authorized access to individual rooms or other regions, as non-limiting examples. As one example, hub device 12 may include a control panel. As another example, hub device 12 may include a “Life and Property Safety Hub®” of Resideo Technologies, Inc.®, of Austin, Texas. Hub device 12 may include a wired connection to an electric power grid, but in some examples may include an internal power source, such as a battery, supercapacitor, or another internal power source.

Sensor devices can be configured to enroll with hub device 12. For example, a sensor device can be configured to exchange sensor data with hub device 12 and/or be controlled by hub device 12 via an access point, such as access point (e.g., WI-FI Router) 33. Sensor devices can be configured to collect or generate sensor data, and transmit the sensor data to hub device 12 for processing, such as via access point 33. In some examples, the sensor device may include a controllable device. A controllable device may be configured to perform a specified function when the controllable device receives instructions (e.g., a command or other programming) to perform the function from hub device 12. Examples of different types of sensor devices will be described below in reference to FIG. 1. Sensor devices can include either a wired connection to an electric power grid or an internal power source, such as a battery, supercapacitor, or another internal power source.

Processing circuitry at the hub device 12 can be configured to communicate with sensor devices of the premises network 20 using one or more wireless communication protocols. Examples of wireless communication protocols may include, but not limited to, a low-power wireless connection protocol, a high-bandwidth connection protocol, or a local area networking protocol. Examples of a low-power connection protocol may include, but are not limited to, IEEE 802.15.4, a low power protocol using a 900 MHz frequency band, or another low-power connection protocol. As used herein, IEEE 802.15.4 may include any standard or specification compliant with IEEE 802.15.4, such, as for example, Zigbee™, ISA100.11a™, WirelessHART™, MiWi™, 6LOWPAN™, Thread™, SNAP™, and other standards or specifications that are compliant with IEEE 802.15.4. That is, for example, IEEE 802.15.4 should be interpreted herein as including implementations relying only on the IEEE 802.15.4 standard as well as implementations that build upon the IEEE 802.15.4 standard with additional specifications, such as, for example, Zigbee™. Examples of a high-bandwidth connection protocol may include, for example, BLUETOOTH (e.g., classic BLUETOOTH, BLUETOOTH low energy, etc.). Examples of a local area networking protocol may include, for example, Wi-Fi™ (e.g., IEEE 802.11 a/b/g/n/ac, etc.).

Processing circuitry at the hub device 12 may be configured to use TDMA for communication in premises network 20. For example, a Wi-Fi™ sub-network (e.g., partition) of the premises network 20, a BLUETOOTH sub-network of the premises network 20, and an IEEE 802.15.4 network of the premises network 20 can operate at a 2.4 GHz frequency (e.g., within a band of frequencies comprising 2.4 GHz). In this example, processing circuitry at the hub device 12 may register each of sensor devices in the premises network 20 to a slot of a superframe. For example, the processing circuitry at the hub device 12 may allocate one sensor device to a first slot of a superframe and allocate another, different sensor device to a second slot of that superframe. Processing circuitry at the hub device 12 may “output” the superframe by outputting a beacon signaling the beginning of the superframe. Each one of sensor devices in the premises network 20 may synchronize with the beacon and output data, back to the hub device 12 (e.g., via access point 33) according to the slots defined by the superframe. In some examples, this processing circuitry can periodically output a superframe to allow sensor devices of the premises network 20 to output data to the hub device 12 (e.g., via access point 33).

Hub device 12 may allocate multiple sensor devices to a single slot of a superframe, but possibly at different portions of the single slot. For example, hub device 12 may allocate one sensor device to a first time portion (e.g., a first 4 ms portion) of an IEEE 802.15.4 slot and allocate another sensor device to a second time portion (e.g., a second 4 ms portion) of the IEEE 802.15.4 slot that is different from the first time portion of the IEEE 802.15.4 slot. In some examples, hub device 12 may allocate one sensor device to a first channel (e.g., 2.402 GHz) of a BLUETOOTH slot and allocate another sensor device to a second channel (e.g., 2.479 GHz) of the BLUETOOTH slot that is different from the first channel.

As noted, in addition to the hub device 12, the premises network 20 can include the access point 33 as well as one or more of a variety of sensor devices. At the example premises network of FIG. 1, illustrative types of sensor devices shown include thermostat 24A, thermostat 24B (collectively, thermostats 24), indoor motion sensor 26A, outdoor motion sensor 26B (collectively, motion sensors 26), door/window contact sensor 28, air vent damper 36A, 36B, 36C (collectively, air vent dampers 36), smart doorbell 37, outdoor air sensor 38, outdoor infrared sensor 40A, indoor infrared sensor 40B (collectively, infrared sensors 40), and mobile device 32. While hub device 12 is shown as a distinct component, hub device 12 may be integrated into one or more of thermostats 24, motion sensors 26, door/window contact sensor 28, air vent dampers 36, smart doorbell 37, outdoor air sensor 38, and infrared sensors 40. The various devices of system 20 are for example purposes only. For example, additional devices may be added to system 20 and/or one or more devices of system 20 may be omitted.

System 20 is a non-limiting example of the techniques of this disclosure. Other example systems may include more, fewer, or different components and/or devices. While FIG. 1 illustrates a mobile phone, mobile device 32 may, in some examples, include a tablet computer, a laptop or personal computer, a smart watch, a wireless network-enabled key fob, an e-readers, or another mobile device. Mobile device 32 and/or access point (e.g., router) 33 may be connected to a wide area network, such as, for example, internet 34. Internet 34 may represent a connection to the Internet via any suitable interface, such as, for example, a digital subscriber line (DSL), dial-up access, cable internet access, fiber-optic access, wireless broadband access, hybrid access networks, or other interfaces. Examples of wireless broadband access may include, for example, satellite access, WiMax™, cellular (e.g., 1X, 2G, 3G™, 4G™, 5G™, etc.), or another wireless broadband access.

Hub device 12 can be in wireless data communication, such as via an access point, such as access point 33, with one or more of thermostats 24, motion sensors 26, door/window contact sensor 28, air vent dampers 36, smart doorbell 37, outdoor air sensor 38, and infrared sensors 40. For example, thermostats 24, motion sensors 26, door/window contact sensor 28, air vent dampers 36, smart doorbell 37, outdoor air sensor 38, and infrared sensors 40 can be indirectly wirelessly connected to hub device 12 via one or more access points (e.g., access point 33) using one or more wireless channels according to a communication protocol, such as, but not limited to, for example, IEEE 802.15.4, BLUETOOTH, or another connection protocol.

Each of thermostats 24, motion sensors 26, door/window contact sensor 28, air vent dampers 36, smart doorbell 37, outdoor air sensor 38, and infrared sensors 40 may include either a sensor device (e.g., a device configured to collect and/or generate sensor data), a controllable device, or both, as described herein. For example, thermostats 24 may include comfort devices having sensors, such as a thermometer configured to measure an air temperature. In some examples, air vent dampers 36 may include devices located within an air vent or air duct, configured to either open or close the shutters of an air vent in response to receiving instructions from hub device 12.

Thermostats 24 may be configured to wirelessly transmit the temperature (e.g., sensor data) directly to hub device 12. Additionally, thermostats 24 may include controllable devices, in that they may activate or deactivate a heating, cooling, or ventilation system in response to receiving instructions from hub device 12. For example, thermostat 24A may collect temperature data and transmit the data to hub device 12. Hub device 12, in response to receiving the temperature data, may determine that a respective room is either too hot or too cold based on the temperature data, and transmit a command to thermostat 24A to activate a heating or cooling system as appropriate. In this example, each of thermostats 24 may include both sensor devices and controllable devices within a single distinct unit.

Indoor and outdoor motion sensors 26 may include security devices configured to detect the presence of a nearby mobile object based on detecting a signal, such as an electromagnetic signal, an acoustic signal, a magnetic signal, a vibration, or other signal. The detected signal may or may not be a reflection of a signal transmitted by the same device. In response to detecting the respective signal, motion sensors 26 may generate sensor data indicating the presence of an object, and wirelessly transmit the sensor data to hub device 12. Hub device 12 may be configured to perform an action in response to receiving the sensor data, such as outputting an alert, such as a notification to mobile device 32, or by outputting a command for the respective motion sensor 26 to output an audible or visual alert. In this example, each of motion sensors 26 may include both sensor devices and controllable devices within a single unit.

Door and/or window contact sensor 28 may include a security device configured to detect the opening of a door or window on which the door and/or window contact sensor 28 is installed. For example, contact sensor 28 may include a first component installed on a door or window, and a second component installed on a frame of the respective door or window. When the first component moves toward, past, or away from the second component, the contact sensor 28 may be configured to generate sensor data indicating the motion of the door or window, and wirelessly transmit the sensor data to hub device 12. In response to receiving the sensor data, hub device may be configured to perform an action such as outputting an alert, such as a notification to mobile device 32, or by outputting a command for the respective contact sensor 28 to output an audible or visual alert. In this example, contact sensor 28 may include a sensor device and a controllable devices within a single unit.

Air vent dampers 36 may be configured to regulate a flow of air inside of a duct. For example, thermostats 24 may generate a control signal to close air vent damper 36A (e.g., when the room is not occupied). In this example, in response to the control signal, air vent damper 36 may close to prevent air from flowing from air vent damper 36A. In some examples, air vent dampers 36 may send sensor data indicating a state (e.g., open or closed) of the respective air vent damper. For instance, air vent damper 36 may output, to thermostats 24 an indication that air vent damper 36 is in an open state.

Smart doorbell 37 may be configured to provide notifications to hub device 12. For example, smart doorbell 37 may be configured to provide a notification (e.g., message) when a button (e.g., doorbell) of smart doorbell 37 is activated. In some examples, smart doorbell 37 may include motion sensor circuitry configured to generate a notification in response to motion detected near smart doorbell 37. In some examples, smart doorbell 37 may be configured to generate video content in response to motion detected near smart doorbell 37. In some examples, smart doorbell 37 may be configured to generate audio content in response to motion detected near smart doorbell 37. For instance, in response to motion detected near smart doorbell 37, smart doorbell 37 may generate video content using a camera and/or audio content using a microphone. In this instance, smart doorbell 37 may output the video content and audio content to hub device 12, which may forward the video content and/or audio content to mobile device 32.

Outdoor air sensor 38 may be configured to generate sensor data indicating, for example, a temperature, humidity, and/or quality (e.g., carbon monoxide, particulate matter, or other hazards) of the surrounding air. In some examples, outdoor air sensor 38 may wireless transmit the sensor data to hub device 12. For instance, outdoor air sensor 38 may periodically output a current or average temperature to thermostats 24 via hub device 12.

Outdoor passive infrared sensors 40 may include security devices configured to detect the presence of a nearby object, such as a person, based on detecting infrared wavelength electromagnetic waves emitted by the object. In response to detecting the infrared waves, passive infrared sensors 40 may generate sensor data indicating the presence of the object, and wirelessly transmit the sensor data to hub device 12. Hub device 12 may be configured to perform an action in response to receiving the sensor data, such as outputting an alert, such as a notification to mobile device 32, or by outputting a command for the respective passive infrared sensor 40 to output an audible or visual alert.

Premises network 20 may include various devices, including, for example, a security device, a water heater, a water flow controller, a garage door controller, or other devices. For example, premises network 20 may include one or more of: a door contact sensor, a motion passive infrared (PIR) sensor, a mini contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, a keypad, and/or other devices.

In accordance with the techniques of the disclosure, hub device 12 and each of thermostats 24, motion sensors 26, door/window contact sensor 28, air vent dampers 36, smart doorbell 37, outdoor air sensor 38, and infrared sensors 40 may be configured to communicate using a frame, such as a superframe, for instance via an access point. While various examples described herein use IEEE 802.15.4 as an example of a first communication protocol and BLUETOOTH as an example of a second communication protocol, in some examples, other protocols may be used.

The sensor devices in the premises network 20 can be grouped into a number of different partitions, and hub device 12 (e.g., control panel) can store a record thereat associating at least a first device (e.g., air vent damper 36A) with a first partition, and first access point defining that first partition, and a second, different device (e.g., air vent damper 36B) with a second, different partition, and a second access point defining that second partition. Likewise, the record stored at hub device 12 can associate other devices (e.g., air vent damper 36C) with other, different partitions. For instance, in the case of the premises network 20 deployed at a premises that is a high rise apartment complex, each floor or each unit of the high rise apartment complex can have a dedicated access point within the premises network 20 and correspond to a different partition, or grouping, of sensor devices associated with that dedicated access point for use in communication with hub device 12.

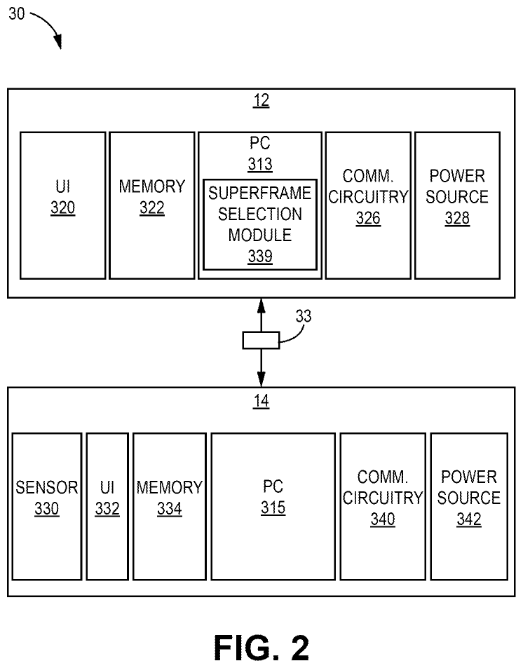

FIG. 2 is a conceptual block diagram of the hub device 12 of FIG. 1 and a sensor device 14, in accordance with some examples of this disclosure. The sensor device 14 can be, for instance, any of the sensor devices shown and/or described with respect to FIG. 1. For example, the hub device 12 and the sensor device 14 can be part of the premises network 20, with the sensor device 14 being part of a first partition of the premises network 20 associated with a first access point 33 and, thus, the sensor device 14 being in communication with the hub device 12 via the first access point 33.

Hub device 12 may include at least a user interface (UI) 320, a memory 322, processing circuitry (PC) 313, communication circuitry 326 (“COMM. CIRCUITRY”), and a power source 328. UI 320 is configured to receive data input from, or output data to, a user. For example, UI 320 may include a display screen, such as a touchscreen, keyboard, buttons, microphone, speaker, camera, or any other user input/output device. Other examples of UI 320 are possible. For example, during an initial setup process, hub device 12 may “scan” a local proximity in order to identify one or more other devices (e.g., devices having recognizable wireless communication capabilities), and then output for display on a display screen a list of the discovered devices for selection by a user. Via UI 320, a user may also specify one or more parameters in order to control or otherwise manage a comfort and/or security system within a building and the surrounding premises. For example, via UI 320, a user may specify one or more air temperature settings or security settings, such as access codes and/or authorized users.

Hub device 12 includes a memory (e.g., non-transitory storage medium) 322 configured to store data, as well as instructions that, when executed by processing circuitry 313, cause hub device 12 to perform one or more techniques in accordance with this disclosure. Communication circuitry 326 may include components, such as an antenna, configured to wirelessly transmit and receive data according to one or more wireless communication protocols. For example, communication circuitry 326 may be configured to transmit and/or receive data according to the IEEE 802.15.4 protocol, Wi-Fi™, and/or the BLUETOOTH protocol where appropriate, according to one or more constraints of the respective data communication protocols (e.g., communication range, energy requirements, etc.).

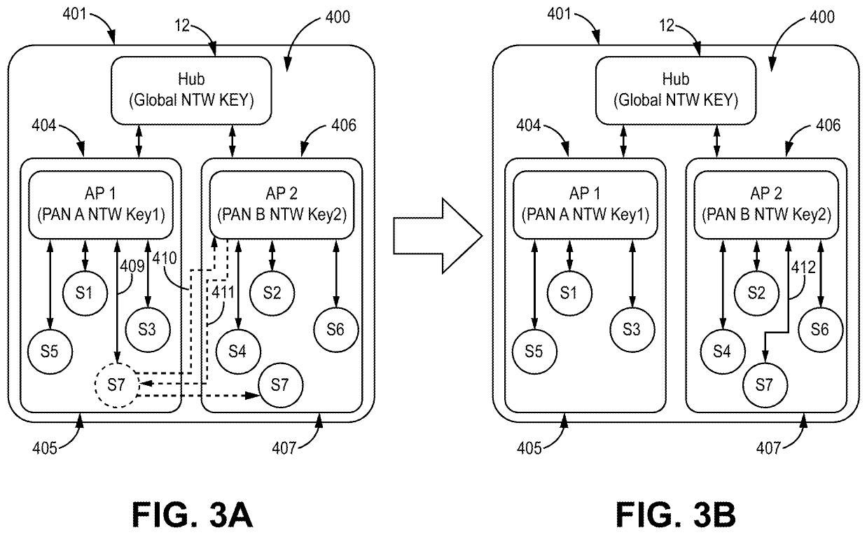

Power source 328 may include a wired connection to an electric power grid, due to the energy-intensive operations performed by hub device 12. However, in some examples, power source 328 may additionally or alternatively include an internal power source, such as a battery or supercapacitor. In the example of FIG. 3, hub device 12 omits a sensor, however, in some examples, hub device 12 may further include one or more sensors

Sensor device 14 may be configured to wirelessly communicate with hub device 12, such as via access point 33. Sensor device 14 may include an incorporated sensor 330, a UI 332, a memory 334, processing circuitry (PC) 315, communication circuitry 340, and a power source 342. In some examples, sensor device 14 may include an incorporated sensor device, such as a motion sensor; passive infrared (PIR) sensor; air temperature and/or humidity sensor; air quality (e.g., carbon monoxide or particulate matter) sensor; or a door or window contact sensor, as non-limiting examples. The PC 315 of the sensor device 14 can include an access point migration module 339 which can include non-transitory computer-executable instructions that, when executed by PC 315, can cause the sensor device 14 to migrate from communication with one access point (e.g., access point 33) in the premises network to another access point in the premises network. Functionality associated with executing the access point migration module 339 will be described further herein.

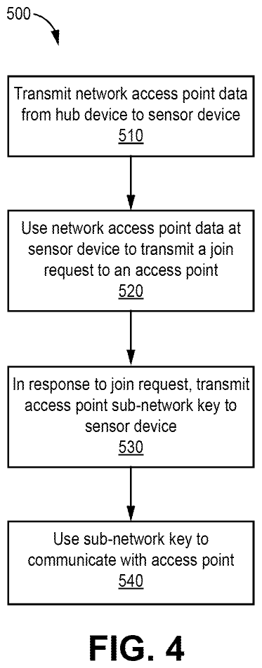

Sensor device 14 can have each of its non-transitory storage medium (e.g., memory 334), sensor element 330 (e.g., configured to detect an ambient condition), and transceiver/communication circuitry 340 (e.g., configured to receive and transmit data via a sub-network associated with a wireless access point within the premises network) coupled to the programmable processing circuitry. And, this programmable processing circuitry 315 at the sensor device 14 can be configured to cause the sensor device 14 to execute the access point migration module 339 (e.g., non-transitory computer-executable instructions configured to cause the PC 315 to execute the following functions) at the sensor device 339 by: transmitting, via the transceiver/communication circuitry 340, data to a first access point of a first sub-network of the premises network; receiving, via the transceiver/communication circuitry 340, network access point data from a hub device of the premises network, the network access point data including an address of a second access point of a second sub-network of the premises network and, for some additional embodiments, an operating channel of the second sub-network of the premises network; using at least the address of the second access point of the second sub-network and, when so included in the network access point data, the operating channel of the second sub-network to transmit, via the transceiver/communication circuitry 340, a transfer request from the sensor device 14 to the second access point of the second sub-network; in response to transmitting the transfer request, receiving, via the transceiver/communication circuitry 340, a second sub-network key from the second access point of the second sub-network; and using the second sub-network key to communicate, via the transceiver, with the second access point. This functionality associated with execution of the access point migration module 339 at the sensor device 14 is further described herein in reference to FIGS. 3A, 3B, and 4.

In some embodiments, as noted, in addition to the network access point data including an address of a second access point of a second sub-network of the premises network, the network access point data can further include an operating channel of the second sub-network of the premises network. When the network access point data also includes an operating channel of the second sub-network of the premises network, the programmable processing circuitry 315 at the sensor device 14 can use the address of the second access point of the second sub-network and the operating channel of the second sub-network to transmit the transfer request from the sensor device 14 to the second access point of the second sub-network to facilitate migration of the sensor device 14 to the second access point of the second sub-network. In other embodiments, the network access point data can include the address of a second access point of a second sub-network of the premises network but not an operating channel of the second sub-network of the premises network. In such embodiments, the sensor device 14 can scan all operating channels to find an operating channel on which the address of the second access point of a second sub-network of the premises network, previously received in the network access point data, is being used. As such, in these embodiments, the sensor device 14 may not need to know the operating channel of the second access point of the second sub-network of the premises network to migrate to the second access point as the sensor device 14 can look for use of the address of the second access point of the second sub-network of the premises network, previously received in the network access point data, when scanning all available operating channels in the premises network.

UI 330 at sensor device 14 can be configured to receive data input from, or output data to, a user. For example, UI 330 may include a display screen, such as a touchscreen, keyboard, buttons, microphone, speaker, camera, or any other user input/output device. Other examples of UI 330 are possible. For example, during an initial setup process, sensor device 14 may “scan” a local proximity in order to identify one or more hub devices, access points, and/or other devices (e.g., devices having recognizable wireless communication capabilities), and then output for display on a display screen a list of discovered devices for selection by a user. Via UI 330, a user may also specify one or more parameters in order to control or otherwise manage a comfort and/or security system within a building and the surrounding premises. For example, via UI 330, a user may specify one or more air temperature settings (e.g., for a thermostat) or security settings, such as access codes and/or authorized users. Sensor device 14 includes a memory 334 configured to store data, as well as instructions that, when executed by processing circuitry 315, cause sensor device 14 to perform one or more techniques in accordance with this disclosure.

As noted, hub device 12 and sensor device 14 can be configured to communicate using a superframe. For example, sensor device 14 may output an enrollment signal to hub device 12. Hub device 12 may assign sensor device 14 a partition, or group, number (e.g., corresponding to a particular sub-network, within the premises network, associated with a particular access point) and output an indication of the group number to sensor device 14. Hub device 12 may then control a timing of communications using the superframe. For example, hub device 12 may specify a start of a superframe using a beacon and identify devices that may communicate by specifying a partition, or group, assigned to the superframe. In this way, sensor device 14 may determine when to output data. For example, sensor device 14 may, in response to a beacon output by hub device 12 indicating the group number assigned to sensor device 14, output data in accordance with the superframe.

FIGS. 3A and 3B illustrate a conceptual block diagram of an embodiment of a system 400 at a premises network 401. Specifically, FIGS. 3A and 3B illustrate an example of a sensor device S7 migrating from wireless communication with one access point 404 of the premises network 401 to wireless communication with another access point 406 of the premises network 401. FIG. 3A illustrates the sensor device S7 at a first sub-network 405 of the premises network 401 and in the process of migrating over to a second, different sub-network 407 of the premises network 401. FIG. 3B illustrates the premises network 401 after the sensor device S7 has migrated from the first sub-network 405 to the second sub-network 407 such that the sensor device S7 at FIG. 3B is now part of the second sub-network 407.

The system 400 can include the hub device 12, first wireless access point 404, second wireless access point 406, and a plurality of sensor device S1-S7. The first wireless access point 404 can be coupled to the hub device 12, and the second wireless access point 406 can be coupled to the hub device 12. Thus, the first wireless access point 404 and the second wireless access point 406 can each be included in the same premises network 401 at a common premises location, and each of the first wireless access point 404 and the second wireless access point 406 can be in communication with hub device 12 at the common premises. The first wireless access point 404 can be associated with the first sub-network 405 of the premises network 401, and the second wireless access point 406 can be associated with the second sub-network of the premises network 401. The premises network 401 can include the hub device 12, first wireless access point 404, first sub-network 405, second wireless access point 406, second sub-network 407, and the sensor devices S1-S7. As shown at the exemplary instance represented by FIG. 3A, the first sub-network 405 can include the first wireless access point 404 and sensor devices S1, S3, S5, and S7 such that sensor devices S1, S3, S5, and S7 can each be in communication with first access point 404 and hub device 12 while the second sub-network 407 can include the second wireless access point 406 and sensor devices S2, S4, S6 such that sensor devices S2, S4, S6 can each be in communication with second access point 406 and hub device 12. As will be described further below, any one or more of the sensor devices S1-S7 can be configured to migrate from one sub-network, and thus migrate from communication with one access point, in the premises network to another sub-network, and thus migrate to communication with another access point, in that same premises network. For the illustrated example at FIGS. 3A and 3B, it is the sensor S7 that is shown migrating from first sub-network 405, and thus migrating from communication with first access point 404, in the premises network 401 to second sub-network 407, and thus migrating to communication with second access point 406, in that same premises network 401.

FIG. 4 is a flow diagram illustrating of an embodiment of a method 500 for sensor device migration from wireless communication with one access point of the premises network to wireless communication with another access point of the premises network. FIGS. 3A, 3B, and 4 will be referenced collectively as follows to describe embodiments of sensor device migration from wireless communication with one access point of the premises network to wireless communication with another access point of the premises network.

At step 510, the method 500 includes transmitting network access point data from a hub device of a network to a sensor device of the network. Referring to FIG. 3A, in one example, sensor device S7 can initially be in communication with first access point 404 and, thus, be part of first sub-network 405. Within the premises network 401, hub device 12 can transmit network access point data to each of sensor devices S1-S7. For example, hub device 12 can transmit network access point data to sensor devices S1, S3, S5, S7 via first access point 404 in the premises network 401, and hub device 12 can transmit network access point data to sensor devices S2, S4, S6 via second access point 406 in the premises network 401.

The network access point data sent to the sensor devices S1-S7 can include data relating to communication parameters for use in communicating with one or more access points 404, 406 in the premises network 401. For instance, in various embodiments, the network access point data sent to the sensor devices S1-S7 from the hub device 12 can include data relating to communication parameters to enable the sensor devices S1-S7 receiving the network access point data to communicate with access points in the premises network 401 to which the network access point data pertains (e.g., each access point 404, 406 in the premises network 401).

For example, the network access point data sent to the sensor devices can include an address of one or more access points 404, 406 (e.g., each of access points 404, 406) in the premises network 401 and/or an operating channel of one or more access points 404, 406 (e.g., each of access points 404, 406) in the premises network 401. In a specific such example, the network access point data sent to the sensor devices can include both an address of one or more access points 404, 406 (e.g., each of access points 404, 406) in the premises network 401 and an operating channel of one or more access points 404, 406 (e.g., each of access points 404, 406) in the premises network 401. The following Table 1 shows one example of network access point data that can be sent from the hub device 12 to one or more (e.g., each) of sensor devices S1-S7:

TABLE 1

| Access Point (AP) in | | Operating Channel of Sub- |
|---|---|---|
| Premises Network | Address of AP | Network and AP |
| AP1 | Address of AP1 | Operating channel of AP1 |
| AP2 | Address of AP2 | Operating channel of AP2 |
| AP3 | Address of AP3 | Operating channel of AP3 |

Table 1 shows access point data for each of three different access points—AP1 (e.g., first access point 404), AP2 (e.g., second access point 406), AP3 (e.g., a third access point not shown in FIGS. 3A, 3B)—within the same premises network 401. In one embodiment, the network access point data sent to one or more (e.g., each) of sensor devices S1-S7 can include the data shown in Table 1. Thus, in such an embodiment, one or more (e.g., each) of sensor devices S1-S7 can receive network access point data from the hub deice 12, via an access point in which the sensor device S1-S7 is in communication, that includes an address (e.g., extended address, such as a unique global MAC address) of a first access point AP1 (e.g., address of first access point 404) in the premises network 401 and an operating channel of the first access point AP1 (e.g., address of first access point 404) in the premises network 401, an address (e.g., extended address) of a second access point AP2 (e.g., address of second access point 406) in the premises network 401 and an operating channel of the second access point AP2 (e.g., address of second access point 406) in the premises network 401, and an address (e.g., extended address) of a third access point AP3 (e.g., a different access point than access points 404, 406) in the premises network 401 and an operating channel of the third access point AP3 in the premises network 401.

For example, in reference to FIG. 3A, sensor devices S1, S3, S5, S7 can receive such network access point data from the hub device 12 via the first access point 404 and sensor devices S2, S4, S6 can receive such network access point data from the hub device 12 via the first access point 404. As such, after receiving this network access point data, sensors S1, S3, S5, S7 that are currently in communication with first access point 404 in FIG. 3A will have the network access point data for executing a migration out of communication with the first access point 404 to communication instead with the second access point 406. Likewise, after receiving this network access point data, sensors S2, S4, S6 that are currently in communication with second access point 406 in FIG. 3A will have the network access point data for executing a migration out of communication with the second access point 406 to communication instead with the first access point 404. Specifically, as one example, with respect to sensor S7 which is executing a migration in the illustrated embodiment, sensor S7 can receive the network access point data from the hub device 12 that includes an address of the second access point 406 of the second sub-network 407 of the premises network 401 and an operating channel of the second sub-network of the network 407 of the premises network 401 (e.g., an operating channel of the second access point 406).

In some embodiments, one or more predetermined conditions can trigger the hub device 12 to transmit the network access point data to the sensor devices S1-S7. As one such example, the predetermined trigger condition can include a new access point being added to the premises network 401 and/or an access point being removed from the premises network 401. Accordingly, in this example, at least when a new access point is added to the premises network 401 and/or an access point is removed from the premises network 401, the hub device 12 can be configured to cause transmission of the network access point data from the hub device 12 to the sensor devices S1-S7. This transmitted network access point data can be updated to include the newly added access point and/or remove the removed access point.

At step 520, the method 500 includes using at least the address of the second access point 406 of the second sub-network 407 and the operating channel of the second sub-network 407 (e.g., operating channel of second access point 406) to transmit a transfer request (also referred to as a “join request”) from the sensor device S7 to the second access point 406 of the second sub-network 407. Referring to FIG. 3A, in one example, sensor device S7 can use at least the address of the second access point 406 and the operating channel of the second sub-network 407 (e.g., operating channel of second access point 406), previously received from the hub device 12, to transmit a transfer request 410 from the sensor device S7 to the second access point 406. For instance, this could include the sensor device S7 submitting the transfer request 410 to the second access point 406 while the sensor device S7 is currently enrolled with the first access point 404 and not currently enrolled with the second access point 406. The transfer request 410 can be a transmission, from the sensor device S7 to the second access point 406, using the operating channel of the second sub-network 407 as specified in the previously received network access point data, that includes: (i) an indication of a desire of the sensor device S7 to communication with the second access point 406, and (ii) the address of the second access point 406. In a further example, the transfer request 410 can additionally include data indicating sensor device S7 is or was in communicative association with first access point 404 before sending the transfer request 410 to the second access point 406, and the second access point 406 can transmit this data indicating sensor device S7 is or was in communicative association with first access point 404 to the hub device 12 so that the hub device 12 can update its record listing of communicative associations (e.g., partitions) within the premises network 401 to reflect to sensor device S7 having migrated out of, and no longer being in, communicative association with the first access point 404.

For instance, prior to using at least the address of the second access point of the second sub-network and the operating channel of the second sub-network to transmit the transfer request from the sensor device to the second access point at step 520, communication may be interrupted or lost between the sensor device and the first access point. Referring to the example of FIG. 3A, prior to the sensor device S7 using at least the address of the second access point 406 of the second sub-network 407 and the operating channel of the second sub-network 407 to transmit the transfer request 410, the sensor device S7 may experience an interruption in, or lose, communication with the first access point 404. The sensor device S7 and/or the first access point 404 can be configured to monitor a wireless communication channel 409 between the sensor device S7 and the first access point 404, and, when it is determined that the wireless communication channel 409 is unable to be used to transmit data between the first access point 404 and the sensor device S7 (e.g., because the communication channel 409 has been interrupted by interference or lost), the sensor device S7 can be configured to then use the previously received, at step 510, address of the second access point of the second sub-network and the operating channel of the second sub-network to transmit the transfer request 410 to the second access point 406 of the second sub-network 407.

At step 530, the method 500 includes, in response to receiving the transfer request from the sensor device, transmitting, from the second access point of the second sub-network, a second sub-network key (“PAN B NTW KEY2”) to the sensor device via a key sub-network key transmission. The second sub-network key (“PAN B NTW KEY2”) can be configured to facilitating encrypted communication between the second access point and communicatively associated sensor devices that store that same second sub-network key (“PAN B NTW KEY2”). Referring to FIG. 3A, in one example, in response to the second access point 406, of the second sub-network 407, receiving the transfer request 410 from the sensor device S7, the second access point 406 can transmit the second sub-network key (“PAN B NTW KEY2”) to the sensor device S7 via a key sub-network key transmission 411. The sensor device S7 can then store the second sub-network key (“PAN B NTW KEY2”) locally at the sensor device S7.

At step 540, the method 500 includes using, at the sensor device, the second sub-network key (“PAN B NTW KEY2”) to communicate with the second access point. Referring to FIG. 3B, the sensor device S7 can use the second sub-network key (“PAN B NTW KEY2”), previously received from the second access point 406 via the key sub-network key transmission 411, to communicate with the second access point 406 via newly established communication channel 412 between sensor device S7 and the second access point 406. Accordingly, with the second sub-network key (“PAN B NTW KEY2”) previously received at the sensor device S7 from the second access point 406 via the key sub-network key transmission 411 as a result of the preceding transfer request 410 transmitted from the sensor device S7 to the second access point 406, the sensor device S7, as shown at the example of FIG. 3B, can be migrated out of communication with the first access point 404 and instead into communication with the second access point 406. In some embodiments, the sensor device S7 can migrate from communication with the first access point 404 to communication with the second access point 406 using the network access point data received from the hub device 12 and the second sub-network key (“PAN B NTW KEY2”) received from the second access point 406 without previously enrolling with the second access point 406. In other embodiments, the sensor device S7 can migrate from communication with the first access point 404 to communication with the second access point 406 using the network access point data received from the hub device 12 and the second sub-network key (“PAN B NTW KEY2”) received from the second access point 406 while at least initially maintaining enrollment of the sensor device S7 with the first access point 404 (e.g., until the second access point 406 transmits an update to the hub device indicating that sensor device S7 should be updated to reflect sensor device S7 being in communication with the second access point 406 and no longer the first access point 404).

In a further embodiment, the method 500 could further include a step of, in response to the sensor device using the second sub-network key to communicate with the second access point at step 540, transmitting, from the second access point to the hub device, a status update indicating that the sensor device has migrated from communication with the first access point to communication with the second access point. Referring to FIG. 3B, in response to the sensor device S7 using the second sub-network key (“PAN B NTW KEY2”) to communicate with the second access point 406, the second access point 406 can then be configured to transmit, from the second access point 406 to the hub device 12, a status update indicating that the sensor device S7 has migrated from communication with the first access point 404 to communication with the second access point 406. The hub device 12 can be configured to maintain a listing of access points in the premises network 401 and communicative associations between specific sensor devices S1-S7 and specific access points 404, 406. For instance, in response to receiving the status update indicating that the sensor device S7 has migrated from communication with the first access point 404 to communication with the second access point 406, the hub device 12 can be configured to change a stored listing thereat from indicating a communicative association between the sensor device S7 and the access point 404 to instead indicate a communicative association between the sensor device S7 and the access point 406.

In a further embodiment of the method 500, the method 500 can additionally include receiving, at the sensor device S7 from the hub device 12 (e.g., via the first access point 404), a global network key (“Global NTW KEY”) prior to transmitting the network access point data from the hub device 12 to the sensor device S7 (e.g., via the first access point 404). The global network key (“Global NTW KEY”) can be configured to facilitating encrypted communication between the hub devices and the other communicatively associated sensor devices, in the premises network 401, that store that same global network key (“Global NTW KEY”). Thus, for instance, for the sensor device S7 to transmit data to the second access point 406, the sensor device S7 can use both the second sub-network key (“PAN B NTW KEY2”) and the global network key (“Global NTW KEY”). As one such example, the transfer request 410 transmitted from the sensor device S7 to the second access point 406 of the second sub-network 407 can includes the global network key (“Global NTW KEY”) previously received from the hub device 12 and stored at the sensor device S7. For instance, in this example, the second sub-network key (“PAN B NTW KEY2”) can be transmitted to the sensor device S7 from the second access point 404 in response to receiving, from the sensor device S7, the transfer request 410 that includes the global network key (“Global NTW KEY”).

In some applications of the teachings provided herein, there may be more than one available access point for a given sensor device to migrate to. In such instances, any of the embodiments disclosed herein can further include one or more configurations to execute a selection of one of the multiple available access points to migrate into communicative connection.

As one illustrative example of executing a selection of one of the multiple available access points to migrate into communicative connection, the system 400 illustrated at FIGS. 3A, 3B could further include a third access point in the premises network 401, and this third access point could include its own associated third sub-network of sensor devices like the sub-networks 405, 407 associated with the respective access points 404, 406. Then, in the method 500 at step 510, the network access point data transmitted from the hub device 12 to the sensor devices of the premises network 401 (e.g., via respective, associated access points 404, 406, third access point) can additionally include network access point data for a third sub-network of the network, with this network access point data for the third sub-network including an address of the third access point of the third sub-network and the operating channel of the third sub-network (e.g., the operating channel of the third access point), for instance as shown at Table 1 above. Also in the method 500, as noted, the sensor device S7 can be configured to receive from the hub device 12 the global network key (“Global NTW KEY”). This embodiment of the method 500 can then additionally include a step of, after transmitting the network access point data and prior to using the address of the second access point 406, scanning, at the sensor device S7, the operating channel of the second sub-network 407 and the operating channel of the third sub-network. Then, based on that scan, the sensor device S7 can select one of the second sub-network 407 and the third sub-network to join. For example, based on the results of the scan, the sensor device S7 can select the second sub-network 407 to migrate into communicative association with.

The sensor device can use the scan of available sub-network operating channels to discern one or more characteristics of each of the scanned, available sub-network operating channels. For instance, the sensor device S7 can receive and store thereat the network access point data from the hub device, such as at least that network access point data shown above at Table 1. Given that the sensor device S7 is initially in communication with the first access point 404 via the operating channel of the first sub-network 405, the sensor device S7 can use this network access point data to determine the operating channel of the second sub-network 407 (e.g., operating channel of the second access point 406) and the operating channel of the third sub-network (e.g., operating channel of the third access point). The sensor device can then scan each of the operating channel of the second sub-network 407 and the operating channel of the third sub-network to discern one or more characteristics of each of the scanned, available operating channel of the second sub-network 407 and the operating channel of the third sub-network.

Such discerned one or more characteristics of each of the scanned, available operating channels can include one or more of signal strength of the respective operating channel and number of sensor devices in communicative association with a respective access point over the respective operating channel. For instance, the sensor device S7 can be configured to receive a beacon signal from the second access point 406 over the respective operating channel of the second sub-network 407 in response to the scan and to receive a beacon signal from the third access point over the respective operating channel of the third sub-network in response to the scan. The sensor device S7 can then use that receipt of those beacons, or other slots of a superframe received from the respective access points over the respective scanned operating channels, to discern one or more characteristics of each of the scanned, available operating channels, such as signal strength of the respective operating channel and number of sensor devices in communicative association with a respective access point over the respective operating channel. As one such example, the sensor device S7 can select the second sub-network 407 to join based on the scan when the scan indicates a signal strength associated with the second sub-network 407 is greater than a signal strength associated with the third sub-network. As another such example, the sensor device S7 can select the second sub-network 407 to join based on the scan when the scan indicates that the second sub-network 407 has fewer sensor devices in communicative association with the second access point 406 over the operating channel of the second sub-network 407 than the number of sensor devices in communicative association with the third access point over the operating channel of the third sub-network. As yet a further example, the sensor device S7 can be configured (e.g., via its programmable processing circuitry) to prioritize signal strength as a criteria for selecting an access point to migrate to over a number of sensor devices in communicative association with a respective access point over the respective operating channel. In this example, the sensor device S7 can be configured to select an access point to migrate into communicative association with having a greatest signal strength of the available access points and associated operating channels, and, when two or more available access points and associated operating channels have a same or equivalent signal strength indicated as a result of the scan, the sensor device S7 can then use a number of sensor devices in communicative association with a respective access point over the respective operating channel to select that access point to migrate into communicative association which has fewer sensor devices in communicative association with it.

The disclosure may be implemented using computer-readable storage media comprising instructions to cause a processor to perform any of the functions and techniques described herein. The computer-readable storage media may take the example form of any volatile, non-volatile, magnetic, optical, or electrical media, such as a RAM, ROM, NVRAM, EEPROM, or flash memory. The computer-readable storage media may be referred to as non-transitory. A computing device may also contain a more portable removable memory type to enable easy data transfer or offline data analysis.

The techniques described in this disclosure, may be implemented, at least in part, in hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

As used herein, the term “circuitry” refers to an ASIC, an electronic circuit, a processor (shared, dedicated, or group) and memory that execute one or more software or firmware programs, a combinational logic circuit, or other suitable components that provide the described functionality. The term “processing circuitry” refers one or more processors distributed across one or more devices. For example, “processing circuitry” can include a single processor or multiple processors on a device. “Processing circuitry” can also include processors on multiple devices, wherein the operations described herein may be distributed across the processors and devices.

Such hardware, software, firmware may be implemented within the same device or within separate devices to support the various operations and functions described in this disclosure. For example, any of the techniques or processes described herein may be performed within one device or at least partially distributed amongst two or more devices. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in an article of manufacture including a non-transitory computer-readable storage medium encoded with instructions. Instructions embedded or encoded in an article of manufacture including a non-transitory computer-readable storage medium encoded, may cause one or more programmable processors, or other processors, to implement one or more of the techniques described herein, such as when instructions included or encoded in the non-transitory computer-readable storage medium are executed by the one or more processors. Example non-transitory computer-readable storage media may include RAM, ROM, programmable ROM (PROM), EPROM, EEPROM, flash memory, a hard disk, a compact disc ROM (CD-ROM), a floppy disk, a cassette, magnetic media, optical media, or any other computer readable storage devices or tangible computer readable media.

In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache). Elements of devices and circuitry described herein may be programmed with various forms of software. The one or more processors may be implemented at least in part as, or include, one or more executable applications, application modules, libraries, classes, methods, objects, routines, subroutines, firmware, and/or embedded code, for example.

Various examples of the disclosure have been described. Any combination of the described systems, operations, or functions is contemplated. These and other examples are within the scope of the following claims.

What is claimed is:

1. A method comprising the steps of:
transmitting network access point data from a hub device of a network to a sensor device of the network, the sensor device being in communication with a first access point of a first sub-network of the network, the network access point data including an address of a second access point of a second sub-network of the network and an operating channel of the second sub-network of the network;
using at least the address of the second access point of the second sub-network and the operating channel of the second sub-network to transmit a transfer request from the sensor device to the second access point of the second sub-network;
in response to receiving the transfer request from the sensor device, transmitting, from the second access point of the second sub-network, a second sub-network key to the sensor device; and
using, at the sensor device, the second sub-network key to communicate with the second access point.

2. The method of claim 1, further comprising:
receiving, at the sensor device from the hub device, a global network key prior to transmitting the network access point data from the hub device to the sensor device.

3. The method of claim 2, wherein the transfer request transmitted from the sensor device to the second access point of the second sub-network includes the global network key.

4. The method of claim 3, wherein the second sub-network key is transmitted to the sensor device from the second access point in response to receiving, from the sensor device, the transfer request that includes the global network key.

5. The method of claim 2, wherein the network access point data further includes network access point data for a third sub-network of the network, the network access point data for the third sub-network including an address of a third access point of the third sub-network and an operating channel of the third sub-network.

6. The method of claim 5, further comprising:
after transmitting the network access point data and prior to using the address of the second access point, scanning, at the sensor device, the operating channel of the second sub-network and the operating channel of the third sub-network.

7. The method of claim 6, further comprising:
selecting, at the sensor device, the second sub-network to join based on the scan.

8. The method of claim 7, wherein the second sub-network is selected to join based on the scan when the scan indicates a signal strength associated with the second sub-network is greater than a signal strength associated with the third sub-network.

9. The method of claim 1, further comprising:
in response to the sensor device using the second sub-network key to communicate with the second access point, transmitting, from the second access point to the hub device, a status update indicating that the sensor device has migrated from communication with the first access point to communication with the second access point.

10. The method of claim 1, wherein the sensor device migrates from communication with the first access point to communication with the second access point using the network access point data from the hub device and the second sub-network key from the second access point and without previously enrolling with the second access point.

11. The method of claim 1, further comprising:
prior to using at least the address of the second access point of the second sub-network and the operating channel of the second sub-network to transmit the transfer request from the sensor device to the second access point, losing communication between the sensor device and the first access point.

12. The method of claim 1, wherein the first access point and the second access point are each included in the network and coupled to the hub device.

13. A sensor device comprising:
programmable processing circuitry;
a non-transitory storage medium coupled to the programmable processing circuitry;
a sensor element configured to detect an ambient condition, the sensor coupled to the programmable processing circuitry; and
a transceiver coupled to the programmable processing circuitry and configured to receive and transmit data via a network,
wherein the programmable processing circuitry is configured to cause the sensor device to:
transmit, via the transceiver, data to a first access point of a first sub-network of the network,
receive, via the transceiver, network access point data from a hub device of a network, the network access point data including a unique global address of a second access point of a second sub-network of the network,
use at least the unique global address of the second access point of the second sub-network, via the transceiver, a transfer request from the sensor device to the second access point of the second sub-network,
in response to transmitting the transfer request, receive, via the transceiver, a second sub-network key from the second access point of the second sub-network, and
use the second sub-network key to communicate, via the transceiver, with the second access point.

14. The sensor device of claim 13, wherein the programmable processing circuitry is configured to cause the sensor device to store, at the non-transitory storage medium, the network access point data including the address of the second access point of the second sub-network of the network and an operating channel of the second sub-network of the network.

15. The sensor device of claim 13, wherein the programmable processing circuitry is further configured to cause the sensor device to: receive, via the transceiver and from the hub device, a global network key prior to receiving the network access point data from the hub device.

16. The sensor device of claim 15, wherein the programmable processing circuitry is further configured to cause the sensor device to: transmit, via the transceiver, the transfer request to the second access point including the global network key.

17. A system comprising:
a hub device of a network;
a first wireless access point coupled to the hub device and associated with a first sub-network of the network;
a second wireless access point coupled to the hub device and associated with a second sub-network of the network; and
a sensor device that includes programmable processing circuitry that is configured to cause the sensor device to:
transmit data to the first access point of the first sub-network,
receive network access point data from the hub device of a network, the network access point data including a unique global address of the second access point of the second sub-network,
use at least the unique global address of the second access point of the second sub-network to transmit a transfer request from the sensor device to the second access point of the second sub-network,
in response to transmitting the transfer request, receive a second sub-network key from the second access point of the second sub-network, and
use the second sub-network key to communicate with the second access point.

18. The system of claim 17, wherein the programmable processing circuitry is further configured to cause the sensor device to:
receive, from the hub device, a global network key prior to receiving the network access point data from the hub device, and
transmit the transfer request to the second access point including the global network key.

19. The system of claim 18,
wherein the network access point data received from the hub device further include an operating channel of the second sub-network, and wherein the programmable processing circuitry of the sensor device is configured to use at least the unique global address of the second access point of the second sub-network and the operating channel of the second sub-network to transmit the transfer request,
further comprising:
a third wireless access point coupled to the hub device and associated with a third sub-network of the network,
wherein the network access point data received at the sensor device from the hub device includes network access point data for the third sub-network of the network that includes an address of the third access point of the third sub-network and an operating channel of the third sub-network, and
wherein the programmable processing circuitry is further configured to cause the sensor device to:
after transmitting the network access point data and prior to using the address of the second access point, scan the operating channel of the second sub-network and the operating channel of the third sub-network.

20. The system of claim 19, wherein the programmable processing circuitry is further configured to cause the sensor device to:
select the second sub-network to join based on the scan when the scan indicates a signal strength associated with the second sub-network is greater than a signal strength associated with the third sub-network.
